(19) United States
(12) Patent Application Publication
(10) Pub. No.: US 2011/0153571 A1
(43) Pub. Date: Jun. 23, 2011

(54) Analyzing Server Copies Of Client Files

(76) Inventors: Philip M. Walker, Fort Collins, CO (US); Jason D. Goldman, Ft Colins, CO (US); Charles M. Mcjilton, Longmont, CO (US)

(21) Appl. No.: 13/000,619

(22) PCT Filed: Sep. 15, 2008
(86) PCT No.: PCT/US2008/076352

§ 371 Date: Feb. 9, 2011

(51) Int. Cl. G06F 17/30

(52) U.S. Cl. 707/654; 707/E17.007

(57) ABSTRACT

One embodiment of a system for analyzing client file systems in accordance with the present disclosure comprises a backup repository storing backup data of file systems of client computers remote from the backup repository. The system further comprises a backup server that analyzes the file systems of the client computers using the backup data at the backup repository and reports a problem detected in a file system of a client computer to a user of the client computer.

### BACKGROUND

A variety of client programs are often used on client systems to analyze various parts of a file system. A client program generally needs to be installed on each client system on a network for each client system to obtain the benefit of the program. For example, existing client programs or tools require a 10× management effort if applied to a workgroup or home network with ten client systems. Such systems are difficult to administer and manage.

### SUMMARY

One embodiment of a system for analyzing client file systems in accordance with the present disclosure comprises a backup repository storing backup data of file systems of client computers remote from the backup repository. The system further comprises a backup server that analyzes the file systems of the client computers using the backup data at the backup repository and reports a problem detected in a file system of a client computer to a user of the client computer.

One embodiment of method of analyzing client file systems in accordance with the present disclosure comprises accessing backup data of file systems of client computers remote from a backup server; analyzing the file systems of the client computers using the backup data; and reporting a problem detected in a file system of a client computer to a user of the client computer.

One embodiment of a computer readable medium in accordance with the present disclosure has instructions executed by a backup server which causes the backup server to access backup data of file systems of client computers remote from the backup server; analyze the file systems of the client computers using the backup data; and report a problem detected in a file system of a client computer to a user of the client computer.

In various embodiments, analysis of the backup data of a client computer may be independent of direct access to the client computer itself. Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of one embodiment of data backup system in accordance with the present disclosure.

FIG. 2 is a flow chart diagram depicting an exemplary functionality and operation of one embodiment of a backup server illustrated in FIG. 1.

FIG. 3 is a block diagram of an instruction execution system that can implement components of the backup server illustrated in FIG. 1.

### DETAILED DESCRIPTION

While embodiments of the present disclosure are susceptible to various modifications and alternative forms, exemplary embodiments thereof have been shown by way of example in the drawings and will herein be described in detail. It should be understood, however, that it is not intended be limited to the particular form disclosed.

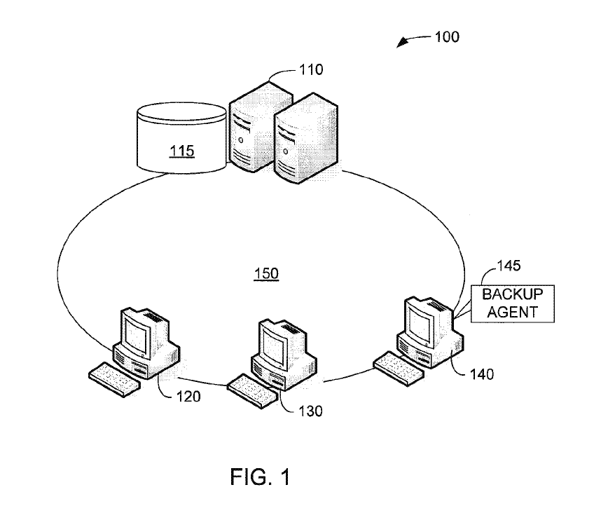

FIG. 1 is a block diagram of a data backup system 100 in which the methods, apparatuses, and systems of the present disclosure are advantageously applied. As part of the system 100, a backup server 110 or a plurality of backup servers interacts with one or more client computers or systems 120, 130, 140 on a network 150. Backup server 110 copies data files or structure of a client computer 120 and stores a backup copy on a storage medium or repository 115. In addition to making copies of data so that these additional copies may be used to restore the original data after a data loss event for client computers, the backup server 110 analyzes secondary or backup copies of the data for client computers 120, 130, 140 on a backup storage repository 115 to generate and output summary reports to the client computers 120, 130, 140. This analysis may include detecting redundant, unused, or corrupted files. Similarly, this could also include virus scanning, spyware program detection, and operating system registry analysis. Note that distinct from detecting invalid backup data that was generated as part of the backup process, the backup server can detect invalid or vulnerable data or data deemed to be unnecessary (e.g., unused data, duplicative data, etc.) that exists on the client computers 120, 130, 140 from analysis of the backup data.

For the storage medium 115, the backup server 110 may, but is not limited to, contain internal storage drives for backup operations or utilize external storage drives to which it has access. The network 150 may be a local area network having several servers and/or workstations 120, 130, 140 that need to be backed up. In various embodiments, the network 150 may be characterized as, but not limited to being, a home network, enterprise network, etc.

Accordingly, in one embodiment, the backup server 110 may constitute a home media server that performs backup operations on home computers. Further, in some embodiments, after installation of a backup agent 145 or comparable agent on a client computer 120, data from the client computer 120 is automatically backed up to the backup server 110. For example, the backup server 110 may complete an image-based back up of every client computer 120, 130, 140 every day or other set period, so that a user can later restore a single file or an entire file system for a client computer 120.

In addition, rather than or in addition to creating multiple redundant backup copies of files that various client systems might have in common, the backup server 110, in one embodiment, may keep one master image, and then write new data for whatever files on a particular system 120 have changed. Therefore, one master version may be stored, and additionally, various updated individual files may be saved for each particular client system 120. Therefore, the backup server 110 may restore individual files or an entire hard drive to a client computer or system 120 in the event of a hardware or software failure on the client system 120.

The backup server 110 may also be integrated with other server functionality such as providing remote access to files, media streaming across the network, a photo sharing Web site, indexing of client files, etc.

The backup server 110 stores backup files from a multiplicity of client computers 120, 130, 140 on the network 150, such as servers and/or workstations. In one embodiment, client agents 145 placed on servers and/or workstations 120, 130, 140 push data over the network 150 to the backup server 110, which then writes the data to the storage medium or repository 115.

On the network 150, file systems of client computers 120, 130, 140 are periodically updated and/or restored from the backup server 110. In accordance with one embodiment of the present disclosure, the backup server 110 analyzes client files stored on a storage medium 115 as backup data, producing summary reports to the client computers 120, 130, 140 regarding redundant, unused, or corrupted files on the client computers 120, 130, 140. In this way, a client file system may be analyzed on the backup server 110 rather than on the client computer 120. Since the backup server 110 has access to and sees files from all the client computer 120, 130, 140, the backup server 110 may apply a single set of file system analysis rules to be applied to all client files.

Therefore, as an alternative to installing individual application instances to the client computers 120, 130, 140 on the network 150 for analyzing the client file computers for a particular objective, such as the detection of corrupted files, malicious files, to index the data files present on the file system, etc., a single application instance may be installed on a backup server 110 which has access to backup data for the client computer(s) 120 on the network 150. This single application instance installed on the backup server 110 may then perform the desired objective of the application on each of the backup data for the client computers 120, 130, 140 on behalf of the client computers. Further, in one or more embodiments, the server may have multiple analysis applications active concurrently—each performing different tasks with the backup data independently.

As an example, among others, a virus scanning application may be installed on the backup server 110 and perform virus scanning on backup data for client computer 120, client computer 130, and client computer 140. The virus scanning application of the backup server 110 may identify a virus on the backup data and ascertain that the portion of backup data belongs to computer 130. Accordingly, the virus scanning application may generate an entry in a log file for the virus scanning application that computer 130 has a virus and provide additional details on the type of virus and the types of files affected on computer 130, as an example. In some embodiments, the virus scanning application may send a report of the scanning operation to an administrator or responsible user associated with computer 130 to let the person know of the presence of the virus on computer 130. Also, the virus scanning application may generate reports for each computer 120, 130, 140 whose file system is analyzed by the backup server 110 regardless of a type of result that is obtained.

In one embodiment, the backup server 110 is able to perform a variety of file system checks on backup data on behalf of the client computers 120, 130, 140. For example, the backup server 110 with backed up registry files from Microsoft Windows® clients is able to scan, repair, and/or report registry file problems on behalf of the client computers 120, 130, 140. Similarly, client files may be scanned on the server 110 for spyware programs that report user activity to third parties, duplicate file copies, corrupted files, registry problems, indexing problems, and residual files left behind by uninstallers on a client computer 120. In one embodiment, a backup agent 145 on a client computer 120 may be installed and used to perform remedial actions in response to detection of a problem with the backup data of the client computer 120. For example, in one embodiment, the backup server 110 may identify a backup file with a problem, correct the problem in the backup file, and push the corrected file to the client computer 120 using the backup agent 145 so that the file may be replaced by the backup agent 145. Alternatively, in one embodiment, the backup server 110 may notify the backup agent 145 of a corrupted file and the backup agent 145 may then quarantine the corrupted file at the client computer 120 or attempt to repair the corrupted file at the client computer 120.

Additional analysis tasks performed by the backup server 110 on backup data in various embodiments include automatic deletion of well-known or configuration-specified debris files. The backup server 110 could be configured to remove various types of “garbage” files, e.g., “**/tmp/*.log” or similar. This could be coupled with an option to remove the corresponding file on a client system 120, either during a restore of the affected directory, or automatically at scheduled intervals, etc. Another analysis task may be the conversion of redundant files into hard links or soft/symbolic links (i.e., symlinks). Therefore, during a restore operation by a client computer 120, the conversions made in the backup data will be used to reconfigure the client computer 120.

Furthermore, the backup server 110 may reconfigure a client computer 120 by replacing selected client directories in the backup data with remotely mounted shares, either on the backup server 110 or another local client (designated on a per-share basis), or on a public or private remote share. This may be appropriate for infrequently accessed, non-critical, or local copies of publicly available data (e.g., data that can be recovered from a public repository).

In one embodiment, an additional analysis task includes maintaining a database (or accessing a remote database) by the backup server 110 for the purpose of validating the file size and/or checksum or other metadata of well-known files generally known to be found in client backup data. For example, the Apache foundation and others provide PGP (Pretty Good Privacy) and MD5 (Message Digest Algorithm 5) hash values for downloadable files. These metadata can be used to validate client copies of these files in the backup data by the backup server 110. Mismatches can be used by the backup server 110 to generate alerts to client systems 120, 130, 140 and/or can cause invalids files to be automatically replaced, either in the client's backup data and/or on directly in the client file system itself.

In one embodiment, the backup server 110 performs the analysis task of generating alerts for copyright and/or other similar license violations, such as a missing copyright file in a well known source tree (e.g., licenses commonly require copyright files to be distributed with source files).

In one embodiment, the backup server 110 performs the analysis task of integrity checking selected client files with a known internal format. Examples of selected client files include, but are not limited to, Windows registry files; archive files, such as those having a tar file format, a JAR file format; a RAR file format, a zip file format; a gzip file format, a cpio file format, etc.; source files with syntax errors, such as Java, C++, Perl, SGML, XML, HTML, CSS, etc.; image files, such as JPEG, TIFF, .PPS, GIF, etc.; and document files having .DOC file format, XML file format, CSV file format, ODF file format, OOXML file format, etc. Furthermore, XML files in the backup data may validated against DTDs (Document Type Definition) or XML (eXtensible Markup Language) Schema. On the basis of the integrity check, the backup server 110 may optionally generate alerts and/or automatically repair detected problems.

In one embodiment, the backup server 110 performs the analysis task of optimization of backup data. For example, email files can be compressed and backup data can be defragmented. On the basis of the optimization, the backup server 110 may optionally generate alerts and/or automatically repair detected problems. Therefore, during a restore operation by a client computer 120, the optimizations made in the backup data will be used to optimize the client computer 120.

By employing a backup server 110 to analyze backup data for client computers 120, 130, 140, the processing power of the backup server 110 is being used to its advantage while not placing increased load on the client computers 120, 130, 140. Further, in many network environments, client systems, such as a mobile laptop computer, may not be connected to the network 150. For example, a worker may take his or her work laptop home with him or her at night. Therefore, a client computer 120 may not be available to have its file system analyzed in accordance with a network administrator's schedule. It therefore makes sense to utilize the backup data that is available for the client systems to perform analysis operations. Further, if individual applications instances are to be used to perform file system analysis on client computers, an administrator has to make sure that each client computer is current with the appropriate software and that the desired application instances are being run on the respective client systems and have not been turned off or subverted by other users. By performing the analysis at the backup server(s), this avoids administrative hassles.

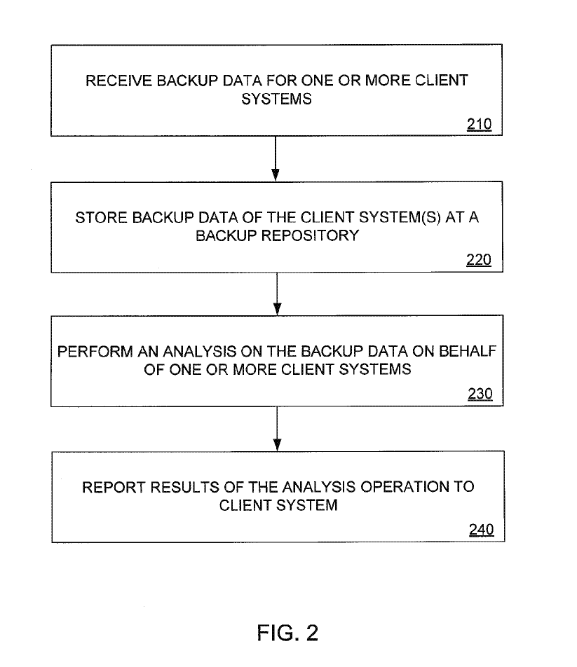

Referring now to FIG. 2, a flow chart is depicted which shows the functionality and operation of an embodiment of the backup server 110. In this regard, each block represents a module, segment, or portion of code, which comprises one or more executable instructions for implementing the specified logical function(s). It should also be noted that in some alternative implementations, the functions noted in the blocks may occur out of the order noted in FIG. 2. For example, two blocks shown in succession in FIG. 2 may in fact be executed substantially concurrently or the blocks may sometimes be executed in the reverse order, depending upon the functionality involved, as will be further clarified hereinbelow.

In FIG. 2, an image of backup data is received for one or more client systems in block 210 by the backup server 110. The backup data of the client system(s) is stored at a backup repository 115 remote from the client system(s) 120 in block 220. In various embodiments, examples of a backup repository may include floppy disks, solid state storage, optical discs, hard disks, magnetic tape, etc. In block 230, an analysis is performed on the backup data on behalf of one or more client systems 120 on the backup data by the backup server 110. The type of analysis may vary and may include virus scanning, registry analysis, files indexing, at a client level, but performed on backup data by a centralized server 110. Results of the analysis operation is then identified with respect to a client system 120 and reported to the client system 120 by backup server 110 in block 240.

Certain embodiments of the present disclosure can be implemented in hardware, software, firmware, or a combination thereof. In some embodiment(s), backup data analysis components and other components are implemented in software or firmware that is stored in a memory or other computer readable medium and that is executed by a suitable instruction execution system. If implemented in hardware, as in an alternative embodiment, components can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

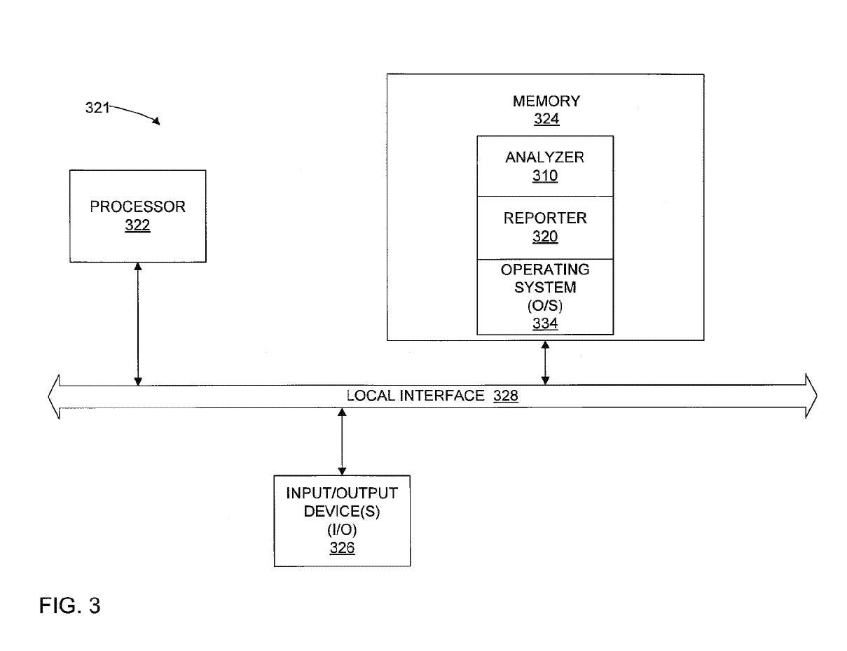

An example of an instruction execution system that can implement the backup data analysis components of the present disclosure is a computer-based device 321 (“computer”) which is shown in FIG. 3. Generally, in terms of hardware architecture, as shown in FIG. 3, the computer 321 includes a processor 322, memory 324, and one or more input and/or output (I/O) devices 326 (or peripherals) that are communicatively coupled via a local interface 328. The local interface 328 can be, for example but not limited to, one or more buses or other wired or wireless connections, as is known in the art. The local interface 328 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 322 is a hardware device for executing software, particularly that stored in memory 324. The processor 322 can be any custom made or commercially available processor, a central processing unit (CPU), an auxiliary processor among several processors associated with the computer 321, a semiconductor based microprocessor (in the form of a microchip or chip set), a macroprocessor, or generally any device for executing software instructions.

The memory 324 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 324 may incorporate electronic, magnetic, optical, and/or other types of storage media. Note that the memory 324 can have a distributed architecture, where various components are situated remote from one another, but can be accessed by the processor 322.

The software in memory 324 may include one or more separate programs, each of which comprises an ordered listing of executable instructions for implementing logical functions. In the example of FIG. 3, the software in the memory 324 includes the backup data analysis components, such as analyzer component 310 and reporter component 320, in accordance with the present disclosure and a suitable operating system (DS) 334. The operating system 334 controls the execution of other computer programs and provides scheduling, input-output control, file and data management, memory management, and communication control and related services.

I/O devices 326 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

When the computer 321 is in operation, the processor 322 is configured to execute software stored within the memory 324, to communicate data to and from the memory 324, and to generally control operations of the computer 321 pursuant to the software. The analyzer component 310, reporter component 320, and the O/S 334, in whole or in part, but typically the latter, are read by the processor 322, perhaps buffered within the processor 322, and then executed.

In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of the present disclosure includes embodying the functionality of the embodiments of the present disclosure in logic embodied in hardware or software-configured mediums.

As discussed above, one embodiment of a system for analyzing client file systems comprises a backup repository 115 storing backup data of file systems of client computers 120 remote from the backup repository 150. The system further comprises a backup server 110 that analyzes the file systems of the client computers 120 using the backup data at the backup repository 115 and reports a problem detected in a file system of a client computer 120 to a user of the client computer 120.

In one embodiment, the backup server 110 analyzes the file systems of the client computers 120 using the backup data to attempt to discover redundant, unused, spyware, or corrupted files that exist on the client computers 120.

In one embodiment, the backup server 110 analyzes the file systems of the client computers 120 using the backup data to attempt to discover registry file problems that exist on the client computers 120.

In one embodiment, the backup server 110 analyzes the file systems of the client computers 120 using the backup data to index the data files present on the file systems of the client computers 120 or to attempt to discover file indexing problems that exist on the client computer 120.

In one embodiment, the backup server 110 instructs a backup agent 145 on a client computer 120 of remedial action that is to be taken on the client computer 120 regarding a computer file identified by the backup server 110 from the backup data.

It should be emphasized that the above-described embodiments are merely possible examples of implementations, merely set forth for a clear understanding of the principles of the disclosure. Many variations and modifications may be made to the above-described embodiment(s) without departing substantially from the principles of the disclosure. All such modifications and variations are intended to be included herein within the scope of this disclosure and protected by the following claims.

Therefore, having thus described various embodiments, at least the following is claimed:

1. A system for analyzing client file systems comprising:
a backup repository storing backup data of file systems of client computers remote from the backup repository; and
a backup server that analyzes the file systems of the client computers using the backup data at the backup repository and reports a problem detected in a file system of a client computer to a user of the client computer.

2. The system of claim 1, wherein the backup server analyzes the file systems of the client computers using the backup data to attempt to discover redundant, unused, spyware, or corrupted files that exist on the client computers.

3. The system of claim 1, wherein the backup server analyzes the file systems of the client computers using the backup data to attempt to discover registry file problems that exist on the client computers.

4. The system of claim 1, wherein the backup server analyzes the file systems of the client computers using the backup data to index the data files present on the file systems of the client computers or to attempt to discover file indexing problems that exist on the client computer.

5. The system of claim 1, wherein the backup server instructs a backup agent on a client computer of remedial action that is to be taken on the client computer regarding a computer file identified by the backup server from the backup data.

6. A computer readable medium having instructions executed by a backup server which causes the backup server to:
access backup data of file systems of client computers remote from the backup server;
analyze the file systems of the client computers using the backup data; and
report a problem detected in a file system of a client computer to a user of the client computer.

7. The computer readable medium of claim 6, wherein the backup data is analyzed to attempt to discover redundant, unused, spyware, or corrupted files that exist on the client computers.

8. The computer readable medium of claim 6, wherein the backup data is analyzed to attempt to discover to registry file problems that exist on the client computers.

9. The computer readable medium of claim 6, wherein the backup data is analyzed to index the data files present on the file systems of the client computers or attempt to discover file indexing problems that exist on the client computer.

10. The computer readable medium of claim 6, wherein the backup server instructs a backup agent on a client computer of remedial action that is to be taken on the client computer regarding a computer file identified by the backup server from the backup data.

11. A method of analyzing client file systems comprising:
accessing backup data of file systems of client computers remote from a backup server;
analyzing the file systems of the client computers using the backup data; and
reporting a problem detected in a file system of a client computer to a user of the client computer.

12. The method of claim 11, wherein the backup data is analyzed to attempt to discover redundant, unused, spyware, or corrupted files that exist on the client computers.

13. The method of claim 11, wherein the backup data is analyzed to attempt to discover to registry file problems that exist on the client computers.

14. The method of claim 11, wherein the backup data is analyzed to index the data files present on the file systems of the client computers or attempt to discover file indexing problems that exist on the client computer.

15. The method of claim 11, wherein the backup server instructs a backup agent on a client computer of remedial action that is to be taken on the client computer regarding a computer file identified by the backup server from the backup data.
